(19) United States
(12) Patent Application Publication
(10) Pub. No.: US 2022/0106917 A1
(43) Pub. Date: Apr. 7, 2022

(54) CONTROL DEVICE

(71) Applicant: AISAN KOGYO KABUSHIKI KAISHA, Obu-shi (JP)

(72) Inventor: Shintaro HAYASHI, Obu-shi (JP)

(21) Appl. No.: 17/488,501

(22) Filed: Sep. 29, 2021

(30) Foreign Application Priority Data
Oct. 2, 2020 (JP) 2020-168027

(51) Int. Cl. F02D 41/00; F02D 41/22

(52) U.S. Cl. CPC F02D 41/0002; F02D 41/221; F02D 2200/0404; F02D 2200/101; F02D 2200/0406

(57) ABSTRACT

A control device may be configured to control an aperture of a throttle valve. The control device may include a pressure detector configured to detect a pressure in an intake pipe of a throttle; a flow rate detector configured to detect an amount of air flowing in the intake pipe; a current value detector configured to detect a current value of a throttle motor operating the throttle valve; a torque estimator configured to estimate torque of an engine based on the detected current value; a first aperture estimator configured to estimate the aperture of the throttle valve based on the detected pressure; a second aperture estimator configured to estimate the aperture of the throttle valve based on the detected amount of air; and a third aperture estimator configured to estimate the aperture of the throttle valve based on the estimated torque and a revolution speed of the engine.

### CROSS-REFERENCE TO RELATED APPLICATION

This application claims priority to Japanese Patent Application No. 2020-168027 filed on Oct. 2, 2020, the entire contents of which are hereby incorporated by reference into the present application.

### TECHNICAL FIELD

This disclosure herewith relates to a control device.

### BACKGROUND

Japanese Patent Application Publication No. H6-93923 describes a control device. The control device adjusts an aperture of a throttle valve. When the aperture of the throttle valve is adjusted, an amount of air flowing in an engine is adjusted. The control device of Japanese Patent Application Publication No. H6-93923 calculates the aperture of the throttle valve by using a throttle sensor for detecting the aperture of the throttle valve. When the throttle sensor fails, the control device estimates the aperture of the throttle valve based on a pressure in an intake pipe of a throttle and the amount of air flowing in the intake pipe.

### SUMMARY

In the technique of Japanese Patent Application Publication No. H6-93923, the aperture of the throttle valve cannot be estimated when a pressure sensor for detecting the pressure in the intake pipe and the flow sensor for detecting the amount of air flowing in the intake pipe fail. Therefore, it is difficult to accurately adjust the aperture of the throttle valve. The present disclosure provides a technique that enables accurate estimation of an aperture of a throttle valve by yet another method in addition to a pressure sensor and a flow sensor.

A control device disclosed herein is a control device of a hybrid vehicle, the hybrid vehicle comprising: an engine; an electric generator configured to operate by the engine; a battery configured to store the electric power generated by the electric generator; a traction motor configured to operate by the electric power stored in the battery; a throttle configured to supply air to the engine; and a throttle valve configured to adjust an amount of air to be supplied to the engine. The control device may be configured to control an aperture of the throttle valve, and the control device may comprise: a pressure detector configured to detect a pressure in an intake pipe of the throttle; a flow rate detector configured to detect an amount of air flowing in the intake pipe; a current value detector configured to detect a current value of a throttle motor operating the throttle valve; a torque estimator configured to estimate torque of the engine based on the detected current value; a first aperture estimator configured to estimate the aperture of the throttle valve based on the detected pressure; a second aperture estimator configured to estimate the aperture of the throttle valve based on the detected amount of air; and a third aperture estimator configured to estimate the aperture of the throttle valve based on the estimated torque and a revolution speed of the engine.

The control device described above comprises the current valve detector configured to detect the current value of the throttle motor operating the throttle valve in addition to the pressure detector configured to detect the pressure in the intake pipe of the throttle and the flow rate detector configured to detect the amount of air flowing in the intake pipe. Since the current value of the throttle motor is correlated with the output of the engine (i.e., torque), the torque of the engine can be estimated by the torque estimator based on the current value. Further, the torque of the engine is correlated with the amount of air supplied to the engine (i.e., the aperture of the throttle valve). Therefore, the aperture of the throttle valve can be estimated based on the current value of the throttle motor. As such, the above-described control device comprises the third aperture estimator configured to estimate the aperture of the throttle valve based on the torque of the engine in addition to the first aperture estimator configured to estimate the aperture of the throttle valve based on the detected pressure and the second aperture estimator configured to estimate the aperture of the throttle valve based on the detected amount of air. Therefore, even when the first aperture estimator and the second aperture estimator malfunction, the aperture of the throttle valve can be accurately estimated by the third aperture estimator.

The control device may be configured to control the aperture of the throttle valve to match a target aperture based on the estimated aperture of the throttle valve. The control device may be configured to determine that a malfunction is occurring in a case where a period until the aperture of the throttle valve matches the target aperture is greater than a predetermined threshold value.

In the case where the period until the aperture of the throttle valve estimated by any of the aperture estimators matches the target aperture is relatively long, it is highly likely that a problem exists with the aperture estimator, the throttle valve, and/or the throttle motor. In the above configuration, in the case where the period until the aperture of the throttle valve matches the target aperture is greater than the predetermined threshold value, it can be determined that a certain malfunction is occurring.

The control device may be configured to execute a first control to estimate the aperture of the throttle valve by any one of the first aperture estimator, the second aperture estimator, and third aperture estimator, and match the aperture of the throttle valve to the target aperture. The control device may be configured to execute a second control to estimate the aperture of the throttle valve by any one other than the one of the aperture estimators in a case where the control device determines that a malfunction has occurred in the first control, and match the aperture of the throttle valve to the target aperture. The control device may be configured to execute a third control to estimate the aperture of the throttle valve by a remaining one of the aperture estimators in a case where the control device determines that a malfunction has occurred in the second control, and match the aperture of the throttle valve to the target aperture.

As described above, since the control device comprises the three aperture estimators, the second control can be executed when a malfunction has occurred in the first control, and the third control can be further executed when a malfunction has occurred in the second control. As such, since the third aperture estimator configured to estimate the aperture of the throttle valve based on the revolution speed of the engine and the estimated torque is provided, it is possible, even when a malfunction has occurred to the other two aperture estimators, to more accurately estimate the aperture and adjust the aperture of the throttle valve to the target aperture as compared with the conventional art.

The control device may be configured to stop the engine and operate the traction motor in a case where the control device determines that a malfunction has occurred in the third control.

When the malfunction has occurred in the third control, it becomes difficult to estimate the aperture of the throttle valve. In such a case, in the above configuration, the engine is stopped and the traction motor is operated by using the power stored in the battery, which enables the hybrid vehicle to continuously travel.

The control device may be configured to control the aperture of the throttle valve to a predetermined aperture in a case where the control device determines that a malfunction has occurred in the third control.

When the malfunction has occurred in the third control, it becomes difficult to estimate the aperture of the throttle valve. In such a case, in the above configuration, the aperture of the throttle valve is controlled to a predetermined aperture. Due to this, a predetermined amount of air is supplied to the engine and power generation is performed by the electric generator, which enables the hybrid vehicle to continuously travel.

The control device may be configured to determine that the throttle motor is malfunctioning in a case where a period until the aperture of the throttle valve estimated by the third aperture estimator matches the target aperture is greater than the predetermined threshold value.

The case where the period until the aperture of the throttle valve estimated based on the torque of the engine (i.e., the current value of the throttle motor) is adjusted to the target aperture is relatively long may be for example the case where the throttle motor does not operate in a normal manner even though the current flows through the throttle motor. Therefore, in the above configuration, in the case where the period until the aperture of the throttle valve is adjusted to the target aperture by using the third aperture estimator is relatively long, a malfunctioning portion can be identified by determining that the throttle motor is malfunctioning (e.g., delay in operation).

The control device may be configured to determine that the throttle valve is malfunctioning in a case where a period until the aperture of the throttle valve estimated by the first aperture estimator or the second aperture estimator matches the target aperture is greater than the predetermined threshold value.

The case where the period until the aperture of the throttle valve is adjusted to the target aperture based on the pressure and the amount of air in the intake pipe is relatively long may be for example the case where the throttle valve does not operate in a normal manner even though the detected values of the pressure and the amount of air are normal. Therefore, in the above configuration, in the case where the period until the aperture of the throttle valve is adjusted to the target aperture by using the first aperture estimator or the second aperture estimator is relatively long, a malfunctioning portion can be identified by determining that the throttle motor is malfunctioning (e.g., the throttle valve being stuck open/closed).

### BRIEF DESCRIPTION OF DRAWINGS

FIG. 1 is a schematic diagram of a hybrid vehicle of an embodiment;

FIG. 2 is a flowchart of an aperture adjustment process of the embodiment;

FIG. 3 is a flowchart of the aperture adjustment process based on a pressure in an intake pipe of the embodiment;

FIG. 4 is a flowchart of the aperture adjustment process based on an amount of air in the intake pipe of the embodiment; and

FIG. 5 is a flowchart of the aperture adjustment process based on torque of an engine of the embodiment.

### DETAILED DESCRIPTION

### First Embodiment

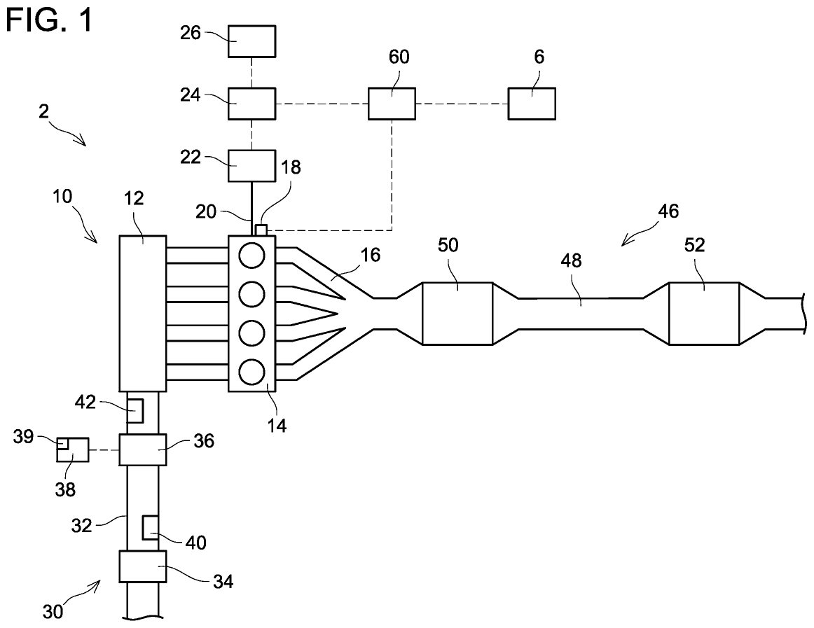

A hybrid vehicle 2 of an embodiment will be described with reference to the drawings. The hybrid vehicle 2 is a vehicle configured to travel using electric power generated by operation of an engine 10. As shown in FIG. 1, the hybrid vehicle 2 comprises an accelerating operation sensor 6, the engine 10, an electric generator 22, a battery 24, a traction motor 26, a throttle 30, an exhaust unit 46, and a control device 60.

The accelerating operation sensor 6 is configured to detect how much a driver of the hybrid vehicle 2 pressed down an accelerator pedal (not shown) (hereinbelow termed “pressed amount”).

The engine 10 comprises an intake manifold 12, an engine body 14, an exhaust manifold 16, and a revolution speed sensor 18. The engine body 14 is connected to the intake manifold 12 and the exhaust manifold 16. A revolution speed of the engine body 14 changes according to for example the pressed amount detected by the accelerating operation sensor 6. The revolution speed sensor 18 is configured to detect a revolution speed of a crankshaft 20 of the engine body 14.

The electric generator 22 is connected to the crankshaft 20 of the engine body 14. The electric generator 22 is for example an alternator. The electric generator 22 is configured to generate electric power by revolution of the crankshaft 20. That is, the engine 10 operates to generate the electric power by the electric generator 22.

The battery 24 is electrically connected to the electric generator 22. The battery 24 is for example a lithium-ion battery. The battery 24 is configured to store the electric power generated by the electric generator 22. Further, the battery 24 is configured to supply the stored electric power to the traction motor 26. Due to this, the traction motor 26 operates and the hybrid vehicle 2 thereby travels.

The throttle 30 comprises an intake pipe 32, a filter 34, a throttle valve 36, a throttle motor 38, a current sensor 39, a flow rate sensor 40, and a pressure sensor 42. The intake pipe 32 is connected to the intake manifold 12. Air flows in the intake pipe 32 from outside the hybrid vehicle 2 toward the intake manifold 12. The filter 34 is configured to collect foreign particles contained in the air flowing in the intake pipe 32.

The throttle valve 36 is disposed inside the intake pipe 32. The throttle valve 36 is for example a butterfly valve. When the throttle valve 36 opens, the air flows toward the intake manifold 12. An amount of the air that flows through the throttle valve 36 and is supplied to the engine 10 increases when an aperture of the throttle valve 36 is larger.

The throttle motor 38 is connected to the throttle valve 36. The throttle motor 38 is for example a stepping motor. The throttle motor 38 is configured to operate the throttle valve 36. Due to this, the aperture of the throttle valve 36 is adjusted.

The current sensor 39 is configured to detect a current value of the throttle motor 38. The flow rate sensor 40 and the pressure sensor 42 are disposed inside the intake pipe 32. The flow rate sensor 40 is configured to detect the amount of air flowing in the intake pipe 32. The pressure sensor 42 is configured to detect a pressure in the intake pipe 32.

The exhaust unit 46 comprises an exhaust pipe 48, a catalytic device 50, and a filter 52. The exhaust pipe 48 is connected to the exhaust manifold 16. Exhaust gas discharged from the engine 10 flows in the exhaust pipe 48 from the exhaust manifold 16 toward the outside of the hybrid vehicle 2.

The catalytic device 50 and the filter 52 are disposed inside the exhaust pipe 48. The catalytic device 50 is for example a three-way catalyst. The catalytic device 50 is configured to detoxicate carbon hydrate, carbon monoxide, and nitric oxide contained in the exhaust gas by chemical reaction. The detoxicated exhaust gas is discharged to the outside of the hybrid vehicle 2. The filter 52 is configured to collect microparticles contained in the exhaust gas, for example.

The control device 60 is incorporated in an Engine Control Unit (ECU). The control device 60 includes a CPU and a memory such as a ROM or a RAM. The control device 60 is electrically connected to each of the accelerating operation sensor 6, the engine body 14, the revolution speed sensor 18, the electric generator 22, the battery 24, the throttle motor 38, the current sensor 39, the flow rate sensor 40, and the pressure sensor 42. FIG. 1 only depicts a connection line between the control device 60 and the accelerating operation sensor 6, a connection line between the control device 60 and the revolution speed sensor 18, and a connection line between the control device 60 and the battery 24. The control device 60 is configured to control operations of the engine body 14, the electric generator 22, the battery 24, and the throttle motor 38. The control device 60 is configured to receive signals from the accelerating operation sensor 6, the revolution speed sensor 18, the flow rate sensor 40, and the pressure sensor 42.

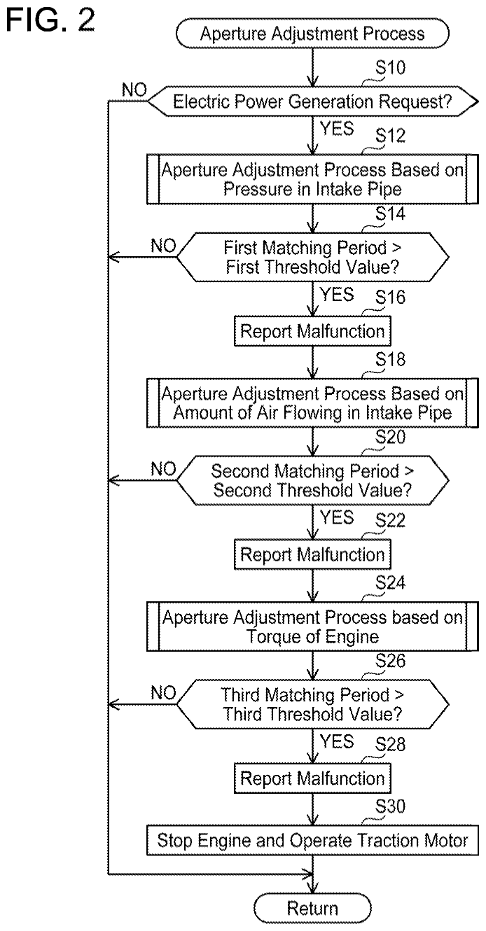

Next, processes performed by the control device 60 will be described. In the present embodiment, the hybrid vehicle 2 does not include a throttle sensor for directly detecting an aperture of the throttle valve 36. Therefore, the control device 60 is configured to estimate an actual aperture of the throttle valve 36 based on the output of any of the sensors 18, 39, 40, 42 described above. Then, the control device 60 adjusts the throttle valve 36 to a target aperture based on the estimated aperture. Hereinafter, with reference to FIG. 2, an aperture adjustment process in which the control device 60 adjusts the aperture of the throttle valve 36 will be described. The aperture adjustment process is performed using the power stored in the battery 24 while the hybrid vehicle 2 is traveling.

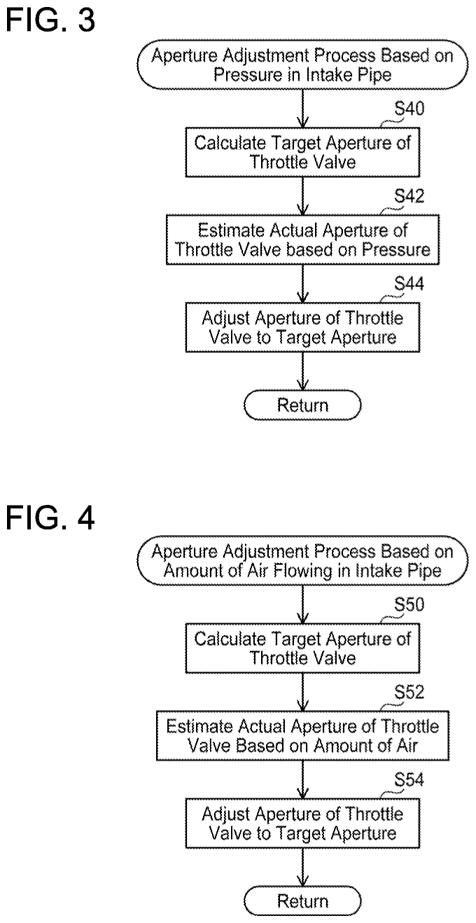

In S10, the control device 60 determines whether an electric power generation request needs to be made to the electric generator 22. The control device 60 determines that the electric power generation request needs to be made to the electric generator 22 for example when an amount of the electric power remaining in the battery 24 becomes equal to or less than a predetermined value or when the pressed amount of the accelerator pedal by the driver of the hybrid vehicle 2 becomes equal to or greater than a predetermined amount. When the control device 60 determines that the electric power generation request does not need to be made (NO in S10), the control device 60 terminates the aperture adjustment process. In this case, since the engine 10 does not operate, the hybrid vehicle 2 travels in the state where the electric power is not generated by the electric generator 22. That is, the hybrid vehicle 2 travels by using the electric power stored in the battery 24. On the other hand, when the electric power generation request needs to be made (YES in S10), “an aperture adjustment process based on the pressure in the intake pipe” is performed. S12 is performed in accordance with a subroutine illustrated in FIG. 3.

In S40 of FIG. 3, the control device 60 calculates the target aperture of the throttle valve 36. The target aperture of the throttle valve 36 is calculated by using a data map related to the target aperture of the throttle valve 36 based on the pressed amount of the accelerator pedal detected by the accelerating operation sensor 6 and the remaining amount of electric power stored in the battery 24. In this data map, the larger the pressed amount of the accelerator pedal is, the larger the target aperture is, and the less amount of electric power remains in the battery 24, the larger the target aperture is. When the control device 60 calculates the target aperture of the throttle valve 36, it operates the engine 10 and starts power generation by the electric generator 22. This data map is stored in advance in the control device 60.

In S42, the control device 60 estimates the actual aperture of the throttle valve 36. Here, the aperture of the throttle valve 36 is estimated based on the pressure in the intake pipe 32. Specifically, the aperture of the throttle valve 36 is estimated by using a data map related to the estimated aperture of the throttle valve 36 based on the detected pressure in the intake pipe 32 and the revolution speed of the crankshaft 20 (i.e., the revolution speed of the engine 10). In this data map, the higher the pressure in the intake pipe 32 is, the larger the estimated aperture is, and the higher the revolution speed of the crankshaft 20 is, the larger the estimated aperture is. This data map is stored in advance in the control device 60.

In S44, the control device 60 adjusts the aperture of the throttle valve 36 to the target aperture calculated in S40. The control device 60 performs feedback control so that the aperture of the throttle valve 36 matches the target aperture based on the actual aperture estimated in S42. That is, the control device 60 adjusts the pressure in the intake pipe 32 and the revolution speed of the crankshaft 20 so that the estimated aperture of the throttle valve 36 matches the calculated target aperture based on the data map related to the estimated aperture of the throttle valve 36. The control device 60 continues to estimate the actual aperture of the throttle valve 36 while performing the feedback control. When the process of S44 is performed, the control device 60 terminates the subroutine of “the aperture adjustment process based on the pressure in the intake pipe”, and proceeds to S14 of FIG. 2.

In S14, the control device 60 determines whether a period until the estimated aperture of the throttle valve 36 matches the target aperture (hereinafter, referred to as a first matching period) is greater than a first threshold value. The first threshold value is for example, but not particularly limited to, 3 seconds. When the control device 60 determines that the first matching period is greater than the first threshold value (YES in S14), the control device 60 proceeds to S16, while when the control device 60 determines that the first matching period is less than the first threshold value (NO in S14), the control device 60 terminates the aperture adjustment process.

In S16, the control device 60 reports to the driver that a malfunction is occurring. The case where the first matching period in S14 is greater than the first threshold value is the case where a relatively long period was required to control the aperture of the throttle valve 36 to the target aperture. In such a case, it is highly likely that the pressure sensor 42, the throttle valve 36, and/or the like is (are) malfunctioning. The malfunction may be failure of the pressure sensor 42 and/or the throttle valve 36 being stuck open/closed, for example. Therefore, in S16, the control device 60 for example turns on a display light on the dashboard of the driver's seat of the hybrid vehicle 2 which indicates that the pressure sensor 42 and/or the throttle valve 36 is (are) malfunctioning.

In S18, the control device 60 executes “an aperture adjustment process based on the amount of air in the intake pipe”. S18 is performed according to a subroutine shown in FIG. 4.

In S50 of FIG. 4, the control device 60 calculates the target aperture of the throttle valve 36. The process of S50 is the same as the process of S40 of FIG. 3.

In S52, the control device 60 estimates the actual aperture of the throttle valve 36. Here, the aperture of the throttle valve 36 is estimated based on the amount of air flowing in the intake pipe 32. Specifically, the aperture of the throttle valve 36 is estimated by using a data map related to the estimated aperture of the throttle valve 36 based on the detected amount of air flowing in the intake pipe 32 and the revolution speed of the crankshaft 20 (i.e., the revolution speed of the engine 10). In this data map, the greater the amount of air flowing in the intake pipe 32 is, the larger the estimated aperture is, and the higher the revolution speed of the crankshaft 20 is, the larger the estimated aperture is. This data map is stored in advance in the control device 60.

In S54, the control device 60 adjusts the aperture of the throttle valve 36 to the target aperture calculated in S50. The control device 60 performs feedback control based on the estimated actual aperture estimated in S52 so that the aperture of the throttle valve 36 matches the target aperture. That is, the control device 60 adjusts the amount of air flowing in the intake pipe 32 and the revolution speed of the crankshaft 20 so that the estimated aperture of the throttle valve 36 matches the calculated target aperture based on the data map related to the estimated aperture of the throttle valve 36. The control device 60 continues to estimate the actual aperture of the throttle valve 36 while performing the feedback control. When the process of S54 is performed, the control device 60 terminates the subroutine of “the aperture adjustment process based on the amount of air in the intake pipe”, and proceeds to S20 of FIG. 2.

In S20, the control device 60 determines whether a period until the estimated aperture of the throttle valve 36 matches the target aperture (hereinafter, referred to as a second matching period) is greater than a second threshold value. The second threshold value is for example, but not particularly limited to, 3 seconds. When the control device 60 determines that the second matching period is greater than the second threshold value (YES in S20), the control device 60 proceeds to S22, while when the control device 60 determines that the second matching period is less than the second threshold value (NO in S20), the control device 60 terminates the aperture adjustment process.

In S22, the control device 60 reports to the driver that a malfunction is occurring. The case where the second matching period in S20 is greater than the second threshold value is the case where, as in the case of YES in S14, a relatively long period was required to control the aperture of the throttle valve 36 to the target aperture. In such a case, it is highly likely that the flow rate sensor 40, the throttle valve 36, and/or the like is (are) malfunctioning. The malfunction may be failure of the flow rate sensor 40 and/or the throttle valve 36 being stuck open/closed, for example. In S22, the control device 60 for example turns on a display light on the dashboard of the driver's seat of the hybrid vehicle 2 which indicates that the flow rate sensor 40 and/or the throttle valve 36 is (are) malfunctioning.

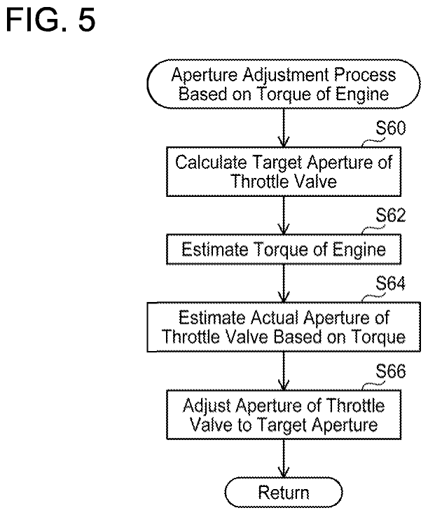

In S24, the control device 60 executes “an aperture adjustment process based on torque of the engine”. S24 is performed according to a subroutine shown in FIG. 5.

In S60 of FIG. 5, the control device 60 calculates the target aperture of the throttle valve 36. The process of S60 is the same as the process of S40 of FIG. 3.

In S62, the control device 60 estimates torque of the engine 10. The torque of the engine 10 is calculated by using a data map related to the torque of the engine 10 based on the revolution speed of the crankshaft 20 (i.e., the revolution speed of the engine 10) detected by the revolution speed sensor 18 and the current value of the throttle motor 38. In this data map related to the torque of the engine 10, the higher the revolution speed of the crankshaft 20 is, the larger the torque of the engine 10 is, and the larger the current value of the throttle motor 38 is, the larger the torque of the engine 10 is. In other words, the torque of the engine 10 is correlated to each of the revolution speed of the crankshaft 20 and the current value of the throttle motor 38. This data map related to the torque of the engine 10 is stored in advance in the control device 60.

In S64, the control device 60 estimates the actual aperture of the throttle valve 36. Here, the aperture of the throttle valve 36 is estimated based on the torque of the engine 10. Specifically, the aperture of the throttle valve 36 is estimated by using a data map related to the estimated aperture of the throttle valve 36 based on the estimated torque of the engine 10 and the revolution speed of the crankshaft 20. In this data map, the greater the torque of the engine 10 is, the larger the estimated aperture of the throttle valve 36 is, and the higher the revolution speed of the crankshaft 20 is, the larger the estimated aperture is. This data map is stored in advance in the control device 60.

In S66, the control device 60 adjusts the aperture of the throttle valve 36 to the target aperture calculated in S60. The control device 60 performs feedback control based on the estimated actual aperture estimated in S64 so that the aperture of the throttle valve 36 matches the target aperture. That is, the control device 60 adjusts the torque of the engine 10 (i.e., the current value of the throttle motor 38) and the revolution speed of the crankshaft 20 so that the estimated aperture of the throttle valve 36 matches the calculated target aperture based on the data map related to the estimated aperture of the throttle valve 36. The control device 60 continues to estimate the actual aperture of the throttle valve 36 while performing the feedback control. When the process of S66 is performed, the control device 60 terminates the subroutine of “the aperture adjustment process based on the torque of the engine”, and proceeds to S26 of FIG. 2.

In S26, the control device 60 determines whether a period until the estimated aperture of the throttle valve 36 matches the target aperture (hereinafter, referred to as a third matching period) is greater than a third threshold value. The third threshold value is for example, but not particularly limited to, 3 seconds. When the control device 60 determines that the third matching period is greater than the third threshold value (YES in S26), the control device 60 proceeds to S28, while when the control device 60 determines that the third matching period is less than the third threshold value (NO in S26), the control device 60 terminates the aperture adjustment process.

In S28, the control device 60 reports to the driver that a malfunction is occurring. The case where the third matching period in S26 is greater than the third threshold value is the case where a relatively long time was required to control the aperture of the throttle valve 36 to the target aperture. In such a case, it is highly likely that the current sensor 39, the throttle valve 36, and/or the like is (are) malfunctioning. The malfunction may be failure of the current sensor 39 and/or the operation of the throttle motor 38 operating the throttle valve 36 being slower than an instructed value, for example. In S28, the control device 60 for example turns on a display light on the dashboard of the driver's seat of the hybrid vehicle 2 which indicates that the current sensor 39 and/or the throttle motor 38 is (are) malfunctioning.

In S30, the control device 60 stops the engine 10 and uses the power stored in the battery 24 to operate the traction motor 26. That is, the control device 60 switches a traveling mode of the hybrid vehicle 2 from a traveling mode that uses the engine 10 to a traveling mode that uses the traction motor 26. When the process of S30 is performed, the control device 60 terminates the aperture adjustment process.

The control device 60 of the embodiment has been described above. The control device 60 of the present embodiment comprises the current sensor 39 configured to detect the current value of the throttle motor 38 for operating the throttle valve 36 as well as the pressure sensor 42 configured to detect the pressure in the intake pipe 32 of the throttle 30 and the flow rate sensor 40 configured to detect the amount of air flowing in the intake pipe 32. Since the current value of the throttle motor 38 is correlated with the output of the engine 10 (i.e., the torque), the torque of the engine 10 can be estimated based on the current value. Further, the torque of the engine 10 is correlated with the amount of air supplied to the engine 10 (i.e., the aperture of the throttle valve 36). Therefore, the aperture of the throttle valve 36 can be estimated based on the current value of the throttle motor 38. As described above, the control device 60 of the present embodiment can estimate the aperture of the throttle valve 36 based on the torque of the engine 10 as well as the detected pressure and the detected amount of air. Therefore, even if a malfunction has occurred in the estimation of the aperture of the throttle valve 36 according to any two aspects, the aperture of the throttle valve 36 can be accurately estimated according to the third aspect.

Further, in the embodiment described above, the aperture of the throttle valve 36 is controlled to match the target aperture based on the estimated aperture of the throttle valve 36 (S44 in FIG. 3, S54 in FIG. 4, S66 in FIG. 5). The control device 60 determines that a malfunction is occurring in the case where the period until the aperture of the throttle valve 36 matches the target aperture is greater than the predetermined threshold value (the first threshold value, second threshold value, or third threshold value) (YES in S14, S20, and S26 of FIG. 2). If the period until the estimated aperture of the throttle valve 36 estimated by any one of the aspects matches the target aperture is relatively long, it is highly likely that an error has occurred in the value used for estimating the aperture of the throttle valve 36 (the output value of the current sensor 39, the flow rate sensor 40, or the pressure sensor 42) and/or a problem exists with the throttle valve 36. Therefore, in the present embodiment, it can be determined that a certain malfunction is occurring in the case where the period until the aperture of the throttle valve 36 matches the target aperture is greater than the predetermined threshold value.

Further, in the present embodiment, the control device 60 estimates the aperture of the throttle valve 36 based on the pressure in the intake pipe 32 (S42 in FIG. 3) and controls so that the aperture of the throttle valve 36 matches the target aperture (S44). Then, when the control device 60 determines that a malfunction has occurred in this control (YES in S14 in FIG. 2), it estimates the aperture of the throttle valve 36 based on the amount of air in the intake pipe 32 (S52 in FIG. 4), and controls so that the aperture of the throttle valve 36 matches the target aperture (S54). When the control device 60 determines that a malfunction has occurred in this control as well (YES in S20 in FIG. 2), it estimates the aperture of the throttle valve 36 based on the torque of the engine 10 (S64 in FIG. 5) and controls so that the aperture of the throttle valve 36 matches the target aperture (S66). As described above, the control device 60 of the present embodiment can estimate the aperture of the throttle valve 36 according to three aspects, therefore, if the estimation of the aperture is performed based on the pressure in the intake pipe 32 as the main control and a malfunction has occurred to this aspect, it is possible to perform the estimation of the aperture by the two aspects different from the main control.

Further, in the present embodiment, in the case where the control device 60 determines that a malfunction has occurred when adjusting the aperture of the throttle valve 36 to the target aperture based on the aperture estimated based on the torque of the engine 10 (YES in S26 in FIG. 2), the control device 60 stops the engine 10 and operates the traction motor 26 (S30). In the present embodiment, when YES is determined in S26, it is difficult to estimate the aperture of the throttle valve 36. Therefore, in such a case, the control device 60 can continue the traveling of the hybrid vehicle 2 by stopping the engine 10 and operating the traction motor 26 using the electric power stored in the battery 24.

### Corresponding Relationships

The pressure sensor 42, the flow rate sensor 40, the current sensor 39 are an example of “pressure detector”, “flow rate detector”, “current value detector”, respectively. The process of S62 of FIG. 5, S42 of FIG. 3, S52 of FIG. 4, S64 of FIG. 5 are an example of the process performed by “torque estimator”, “first aperture estimator”, “second aperture estimator”, “third aperture estimator”, respectively. The process of S12, S18, and S24 in FIG. 2 are an example of “first control”, “second control”, and “third control”, respectively.

While specific examples of the present disclosure have been described above in detail, these examples are merely illustrative and place no limitation on the scope of the patent claims. The technology described in the patent claims also encompasses various changes and modifications to the specific examples described above. Variants of the above-described embodiments will herein be listed.

### Variants

In the flowchart of FIG. 2, the subroutines (“the aperture adjustment process based on the pressure in the intake pipe”, “the aperture adjustment process based on the amount of air in the intake pipe” and “the aperture adjustment process based on the torque of the engine”) may be performed in any order. That is, the processes of S12 to S16, the processes of S18 to S22, and the processes of S24 to S28 may be executed in a random order.

In S30 of FIG. 2, the aperture of the throttle valve 36 may be controlled to a predetermined aperture. If YES is determined in S26, it becomes difficult to estimate the actual aperture of the throttle valve 36. In such a configuration, by controlling the aperture of the throttle valve 36 to the predetermined aperture, a predetermined amount of air is supplied to the engine 10 and power generation is performed by the electric generator 22, which enables the hybrid vehicle 2 to continuously travel.

Specific examples of the present invention has been described in detail, however, these are mere exemplary indications and thus do not limit the scope of the claims. The art described in the claims include modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. A control device of a hybrid vehicle, the hybrid vehicle comprising:
an engine;
an electric generator configured to operate by the engine;
a battery configured to store the electric power generated by the electric generator;
a traction motor configured to operate by the electric power stored in the battery;
a throttle configured to supply air to the engine; and
a throttle valve configured to adjust an amount of air to be supplied to the engine,
wherein the control device is configured to control an aperture of the throttle valve, and
the control device comprises:
a pressure detector configured to detect a pressure in an intake pipe of the throttle;
a flow rate detector configured to detect an amount of air flowing in the intake pipe;
a current value detector configured to detect a current value of a throttle motor operating the throttle valve;
a torque estimator configured to estimate torque of the engine based on the detected current value;
a first aperture estimator configured to estimate the aperture of the throttle valve based on the detected pressure;
a second aperture estimator configured to estimate the aperture of the throttle valve based on the detected amount of air; and
a third aperture estimator configured to estimate the aperture of the throttle valve based on the estimated torque and a revolution speed of the engine.

2. The control device according to claim 1, wherein
the control device is configured to:
control the aperture of the throttle valve to match a target aperture based on the estimated aperture of the throttle valve; and
determine that a malfunction is occurring in a case where a period until the aperture of the throttle valve matches the target aperture is greater than a predetermined threshold value.

3. The control device according to claim 2, wherein
the control device is configured to:
execute a first control to estimate the aperture of the throttle valve by any one of the first aperture estimator, the second aperture estimator, and third aperture estimator, and match the aperture of the throttle valve to the target aperture;
execute a second control to estimate the aperture of the throttle valve by any one other than the one of the aperture estimators in a case where the control device determines that a malfunction has occurred in the first control, and match the aperture of the throttle valve to the target aperture; and
execute a third control to estimate the aperture of the throttle valve by a remaining one of the aperture estimators in a case where the control device determines that a malfunction has occurred in the second control, and match the aperture of the throttle valve to the target aperture.

4. The control device according to claim 3, wherein
the control device is configured to stop the engine and operate the traction motor in a case where the control device determines that a malfunction has occurred in the third control.

5. The control device according to claim 3, wherein
the control device is configured to control the aperture of the throttle valve to a predetermined aperture in a case where the control device determines that a malfunction has occurred in the third control.

6. The control device according to claim 2, wherein
the control device is configured to determine that the throttle motor is malfunctioning in a case where a period until the aperture of the throttle valve estimated by the third aperture estimator matches the target aperture is greater than the predetermined threshold value.

7. The control device according to claim 2, wherein
the control device is configured to determine that the throttle valve is malfunctioning in a case where a period until the aperture of the throttle valve estimated by the first aperture estimator or the second aperture estimator matches the target aperture is greater than the predetermined threshold value.
